(19) United States
(12) Patent Application Publication
(10) Pub. No.: US 2017/0091464 A1
(43) Pub. Date: Mar. 30, 2017

(54) SYSTEMS AND METHODS FOR LINKING MEDICAL RECORDS WITH IMAGES FOR DISTRIBUTION

(71) Applicant: Olah Healthcare Technology, Inc., Columbus, OH (US)

(72) Inventors: Frederick Ray Richards, Hilliard, OH (US); Brian David Olah, New Albany, OH (US)

(21) Appl. No.: 14/986,723

(22) Filed: Jan. 3, 2016

Related U.S. Application Data
(63) Continuation of application No. 14/865,506, filed on Sep. 25, 2015.

(51) Int. Cl. G06F 21/60; G06F 21/62; H04L 29/06

(52) U.S. Cl. CPC G06F 21/606; H04L 63/083; G06F 21/6263

(57) ABSTRACT

Systems and methods are provided access to medical images and clinical data are disclosed herein. In an aspect, disclosed is a method comprising requesting access, by an application executing on a first user network device, to a first authorized set of data files comprising a first authorized set of video files or a first authorized set of image files, wherein the data files are located at a data repository. Furthermore, in an aspect, the method comprises receiving, by the application executing on the first user network device, an embedded link comprising a customized bit pattern within a message from a set of senders, by the first device, wherein the embedded link comprises a set of characters representing a personal health identifier and a set of data repository access information, wherein the embedded link points to the first set of authorized data files at the data repository.

### CROSS REFERENCED TO RELATED APPLICATION

This application claims the benefit of U.S. patent application Ser. No. 14/865,506, filed on Sep. 25, 2015, and entitled “SYSTEMS AND METHODS FOR LINKING MEDICAL RECORDS WITHIN CLAIM MESSAGES”, the entirety of which application is hereby incorporated by reference herein.

### TECHNICAL FIELD

This application relates generally to systems and methods for accessing and sending medical images over a network.

### BACKGROUND

Since medical images were introduced in a clinical setting, the healthcare community and its vendors have struggled to develop an effective distribution model to distribute images internally and externally. Early in the evolution of imaging, ‘films’ were physically stored and manually transported. As technology advanced, vendors became adept to storing images in ‘databases’. Even with the evolution of storing images in databases and more recently consolidated databases, also referred to as Vendor Neutral Archives (VNAs), the problem still persisted with the distribution of images within the healthcare provider community and the patient community.

To alleviate the situation of bulky films being printed and either couriered to other physicians or handed over to a patient, CD's and eventually DVDs were introduced as vehicles for the clinician to hand the images over to the patient so they could be the courier for the healthcare community. This not only became the de-facto standard but also evolved into a tactical advantage to the imaging institution to place the burden of image transfer onto the patient. The common practice in every hospital today is either burning a CD/DVD or printing on expensive paper and handing over to the patient.

All of these mechanisms for image sharing are antiquated and impractical for empowering patients to access and maintain control over their images. Furthermore, given the disjointed nature of many digital systems (e.g., electronic medical record systems), users (e.g., clinicians) must often login to numerous systems outside of their current environment to perform different activities related to servicing a patient. Additionally, there are currently no solutions to address the mobile and fluid needs of the patients' lack of access or control of their own clinical content. Clearly, there is a need for new technologies to solve the problems described above.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with facilitating the access to clinical data including medical images via an application executing on a network device are disclosed. In accordance with a non-limiting embodiment, in an aspect, a system is provided comprising a processor, communicatively coupled to a memory, that executes or facilitates execution of executable components stored in a non-transitory computer readable medium, the executable components comprising: a request component that requests access, by an application executing on a first device, to a first authorized set of data files comprising a first authorized set of video files or a first authorized set of image files, wherein the data files are located at a data repository: a permission component that receives permission, by the application executing on the first device, to access the first authorized set of data files based on a set of submitted information; a messaging component that receives, by the application executing on the first device, an embedded link within a message from a set of senders, wherein the embedded link comprises a customized bit pattern, a set of characters representing a personal health identifier and a set of data repository access information, and wherein the embedded link points to the first set of authorized data files at the data repository; and an access component that accesses, by the application executing on the first device, the first authorized set of data files via the embedded link.

In various aspects, the system further comprises a notification component that provides a notification that a message or a data file of the first authorized set of data files is received or sent. Furthermore, in an aspect, the system can comprise a selection component that selects the first authorized set of data files, via the application executing on a third device, from a set of data files comprising the first authorized set of data files and a set of unauthorized data files. In yet another aspect, the system can employ a sharing component that shares a subset of authorized data files of the first authorized set of data files with the application executing on a second device based on a second identifier associated with the second device.

The disclosure further discloses a method, comprising requesting access, by an application executing on a first user network device, to a first authorized set of data files comprising a first authorized set of video files or a first authorized set of image files, wherein the data files are located at a data repository; receiving permission, by the application executing on the first user network device, to access the first authorized set of data files based on a set of submitted information; receiving, by the application executing on the first user network device, an embedded link comprising a customized bit pattern within a message from a set of senders, by the first device, wherein the embedded link comprises a set of characters representing a personal health identifier and a set of data repository access information, wherein the embedded link points to the first set of authorized data files at the data repository; and accessing, by the application executing on the first user network device, the first authorized set of data files, by the first user network device, via the embedded link.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting embodiment depicting a system for accessing medical data using an application executing on a user network device.

FIG. 2 illustrates an example non-limiting embodiment depicting a system for accessing medical data using an application executing on a user network device, wherein the system comprises a request component, a permission component, a messaging component, and an access component.

FIG. 3 illustrates an example non-limiting embodiment depicting a system for accessing medical data using an application executing on a user network device, wherein the system comprises a request component, a permission component, a messaging component, an access component, and a verification component.

FIG. 4 illustrates an example non-limiting embodiment depicting a system for accessing medical data using an application executing on a user network device, wherein the system comprises a request component, a permission component, a messaging component, an access component, a verification component, and a notification component.

FIG. 5 illustrates an example non-limiting embodiment depicting a system for accessing medical data using an application executing on a user network device, wherein the system comprises a request component, a permission component, a messaging component, an access component, a verification component, a notification component, and a selection component.

FIG. 6 illustrates an example non-limiting embodiment depicting a system for accessing medical data using an application executing on a user network device, wherein the system comprises a request component, a permission component, a messaging component, an access component, a verification component, a notification component, a selection component, and a sharing component.

FIG. 7 illustrates an example non-limiting embodiment depicting a system for accessing medical data using an application executing on a user network device, wherein the system comprises a request component, a permission component, a messaging component, an access component, a verification component, a notification component, a selection component, a sharing component, and an incorporation component.

FIG. 8 illustrates an example non-limiting embodiment depicting a system for accessing medical data using an application executing on a user network device, wherein the system comprises a request component, a permission component, a messaging component, an access component, a verification component, a notification component, a selection component, a sharing component, an incorporation component, and a restriction component.

FIG. 9. illustrates an example non-limiting embodiment depicting a system for accessing medical data using an application executing on a user network device, wherein the system comprises a request component, a permission component, a messaging component, an access component, a verification component, a notification component, a selection component, a sharing component, an incorporation component, and a restriction component.

FIG. 10 illustrates an example non-limiting embodiment depicting a method for accessing medical data using an application executing on a user network device comprising requesting access, receiving permission, receiving an embedded link, and accessing the first authorized set of data files.

FIG. 11 illustrates an example non-limiting embodiment depicting a method for accessing medical data using an application executing on a user network device comprising requesting access, receiving permission, receiving an embedded link, accessing the first authorized set of data files, and providing a notification.

FIG. 12 illustrates an example non-limiting embodiment depicting a method for accessing medical data using an application executing on a user network device comprising requesting access, receiving permission, receiving an embedded link, accessing the first authorized set of data files, and selecting the first set of data files.

FIG. 13 illustrates an example non-limiting embodiment depicting a method for accessing medical data using an application executing on a user network device comprising requesting access, receiving permission, receiving an embedded link, accessing the first authorized set of data files, and sharing the first set of data files.

FIG. 14 illustrates an example non-limiting embodiment depicting a method for accessing medical data using an application executing on a user network device comprising requesting access, receiving permission, receiving an embedded link, accessing the first authorized set of data files, and facilitating a granting of permission to share the first authorized set of data files.

FIG. 15 is a block diagram representing an exemplary non-limiting networked environment in which the various embodiments can be implemented.

FIG. 16 is a block diagram representing an exemplary non-limiting computing system or operating environment in which the various embodiments may be implemented.

### DETAILED DESCRIPTION

### Overview

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

By way of introduction, the subject matter disclosed in this disclosure provides systems, methods and devices to allow a user to access, consume, view, and share medical images with other users using a mobile device. In an aspect, a user can employ a user device (e.g., a smart phone, a laptop computer, a tablet, a desktop computer, a server computer, etc.) to capture, store, access and view medical images (e.g., ultrasounds, x-rays, computed tomography scans, mammography scans, molecular imaging, MRI images, SPECT images, PET images, medical pictures, medical video, self-captured images, etc.) and medical information (e.g., medical charts, health records, prescriptions, orders, progress notes, test results, medical history, voice recordings, etc.).

In a non-limiting example embodiment, a user receives a medical imaging scan at a medical appointment, such as a fetal ultrasound during a particular week of gestation (e.g., 8-10, 16, 20, 24, 30+ weeks). The patient can then choose whether they wish to view the ultrasound images via a mobile device application. Upon the patients consent, the ultrasound images are collected at a historian image database. The patient can receive a correspondence (e.g., text message, e-mail, etc.) inviting them to join the historian image application by entering an activation code using the application.

The user can download the application, enter the received (e.g., via text or e-mail) activation code, and proceed to view approved (e.g., physician or technician approved) images. The application may be a stand-alone application, a website or other function of a web browser accessed over the Internet, or any other suitable application configuration. In an aspect, the application can share the images with other devices such as a physician's device, family devices, or friend's devices. The sharing of images amongst a variety of other devices facilitates the creation of a historian imaging health network, where users (e.g., patients, family members, support network) have control over their own medical content and can access and distribute such medical content through individual consent within the users health network

### Example System Architectures

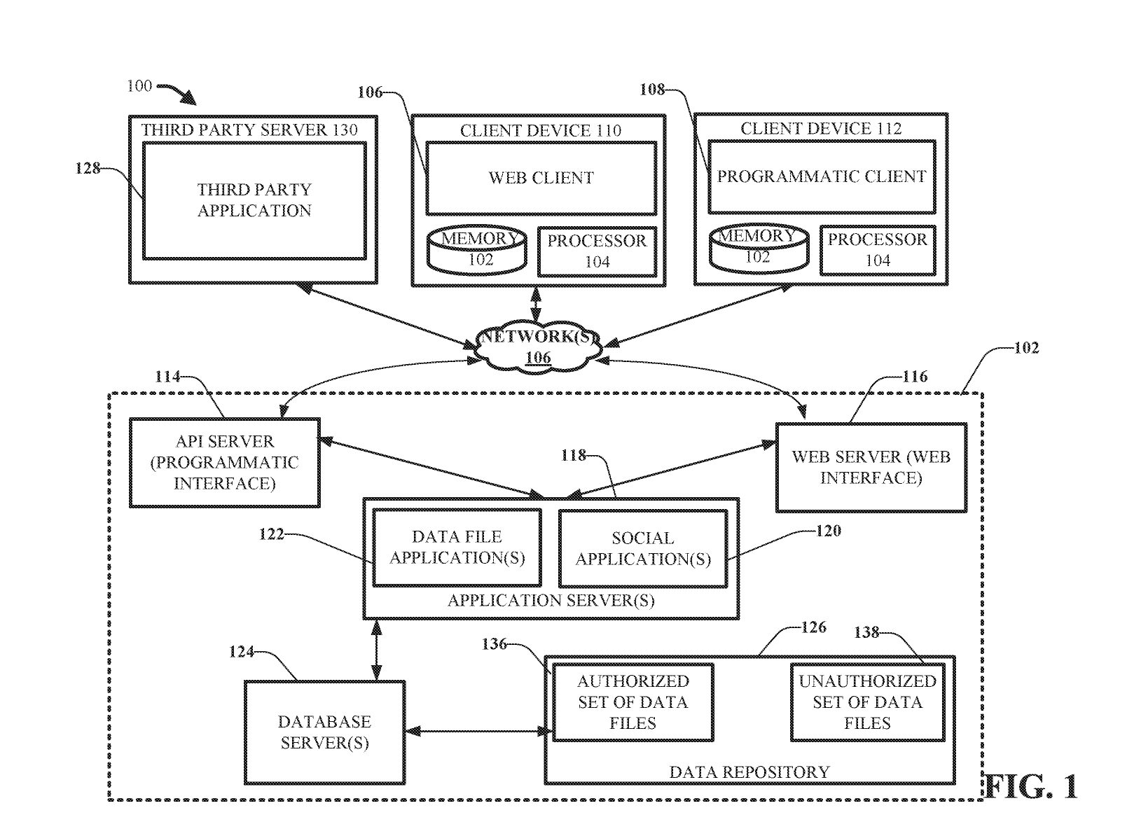

Turning now to the drawings, in which like numerals represent like (but not necessarily identical) elements throughout the figures, example embodiments of the disclosed subject matter are described. Turning to FIG. 1, illustrated is a network diagram depicting a non-limiting embodiment of a client-server system 100, within which one example embodiment can be deployed for accessing medical images. As depicted in FIG. 1, a networked system 102, in the example forms a network-based system that provides server-side functionality, via a network 106 (e.g., the Internet, Wide Area Network (WAN), Local Area Network (LAN), an intranet, a mobile telephone network, or any combination thereof) to one or more clients, such as non-limiting embodiments of a client device illustrated as client device 110 or client device 112 (also referred to throughout the application as first user network device, second user network device, third user network device, fourth user network device, and fifth user network device, where each network user device can be either a client device 110 or client device 112). For example, the client can be a web client 106 (e.g., a browser), and a programmatic client 108 (e.g., also referred to as an application executing on the user network device) executing on client device 110 and client device 112 respectively. Thus the application can be executed as a web client (e.g., using a browser) on a client device 110 or as a programmatic client (e.g., mobile application) executing on client device 112.

Each client device 110 or client device 112 can comprise a communication module capable of transmitting and receiving data over the network 106. For example, each client device 110 and client device 112 can include a server, desktop computer, laptop computer, tablet, smart phone, handheld computer, personal digital assistant (“PDA”), or any other wired or wireless, processor-driven device. For instance, in a non-limiting embodiment, the client device 110 and client device 112 can be operated by end-users (e.g., patients, family, friends), consumers, merchants (e.g., health providers, physicians, hospitals, etc.), or vendors (e.g., health insurance payers). Throughout the discussion of example embodiments, it should be understood that the terms “data” and “information” are used interchangeably herein to refer to text, images, audio, video, or any other form of information that can exist in a computer-based environment.

Each client device 110 or client device 112 can further comprise modules that facilitate the sending of images (e.g., photographs), the receipt of images, a user interface module, a storage module, a messaging module, and other such module to facilitate operation of the application executing on the client device 110 or 112. The modules are configured to communicate with one another via a bus, shared memory or a switch. The user interface may allow for users to share images with other users. Application server 118 also comprises modules. For instance, a user interface module can cause a user interface to be presented to a client device 110 or 112. The user interface may include options for accessing, sharing, or viewing medical images. In some instances, the client device 110 or client device 112 accesses the application server 118 to retrieve medical images (e.g., using a link embedded in a message) and medical data. In another embodiment, the client device 110 or client device 112 accesses the application server 118 to transmit an image to the client device 110 or client device 112. Additional details regarding the functionality of modules are detailed below in the specification.

In an aspect, the Application Program Interface (API) server 114 and a web server 116 are coupled to, and provide programmatic and web interfaces respectively, to, one or more application servers 118. In this example, the application servers 118 host one or more application (e.g., social application 120 and data file applications 122). The application servers 118 are, in turn, shown to be coupled to one or more databases servers 124 that facilitate access to one or more data repository 126 (e.g., database storing medical images).

The social applications 120 may provide a number of social functions and services to users that access the networked system 102. The data file applications 122 may provide a number of image services and access to clinical data functions to users. The data file applications 122 may allow users to store images, modify images, delete images, and send images to other users, including via the social applications 120. While the social applications 120 and data file applications 122 are shown in FIG. 1 to each form part of the networked system 102, it will be appreciated that, in alternative embodiments, the data file applications 122 may form part of an image service that is separate and distinct from the networked system 102. Furthermore, the data file application 122 and social application 120 can be part of a single programmatic application 108 or web client application 106.

Further, while the system 100 shown in FIG. 1 employs a client-server architecture, the present invention is of course not limited to such an architecture, and could equally well find application in a distributed, or peer-to-peer, architecture system, for example. The various social applications 120 and data file applications 122 could also be implemented as standalone software programs, which do not necessarily have networking capabilities. The web client 106 accesses the various social applications 120 and data file applications 122 via the web interface supported by the web server 116. Similarly, the programmatic client 108 accesses the various services and functions provided by the social applications 120 and image applications 122 via the programmatic interface provided by the API server 114.

The programmatic client 108 may, for example, be a medical image application that enables users to access, view, manage, download, and share, medical photos on the networked system 102, and to perform communications between the programmatic client 108 and the networked system 102. The image application 122 can perform image management, artistic, and administrative tasks related to the medical images (e.g., adding filters to the images, editing images using image tools, geo-locational mapping of images, etc.).

Alternatively, or additionally, the client device 110 or client device 112 can access medical images. The medical image data can also be synchronized between the image application 122 and the social application 120. For example, a user may upload a medical image photo to the social application 120. The image application 122 can transfer the photo to the social application 120. The image application 122 can provide other (e.g., non-medical) photos to the social application 120. The social application 120 can add the other photos to the social account of the user, for example, for display to friends, family, medical practitioners of the user. As another example, the social application 120 can transfer all uploaded photos to the image application 122.

The client device 110 or client device 112 may present information to a user. For example, the client device 110 may be running a web browser presenting a web page. The user may wish to access medical records on a web page, wherein the web page may present the user with options to upload pictures, download pictures, delete pictures, and send pictures, among other possible functions. The user may be a user of a social network, and the web page may present the user with options to configure the user's relationship with other users (e.g., friends, ignore, none), to update contact information (e.g., physical address, email address, phone number, user names on other social networks), to update privacy settings, and so on.

Example Systems and Methods for Accessing Medical Images within an Application on a Client Device

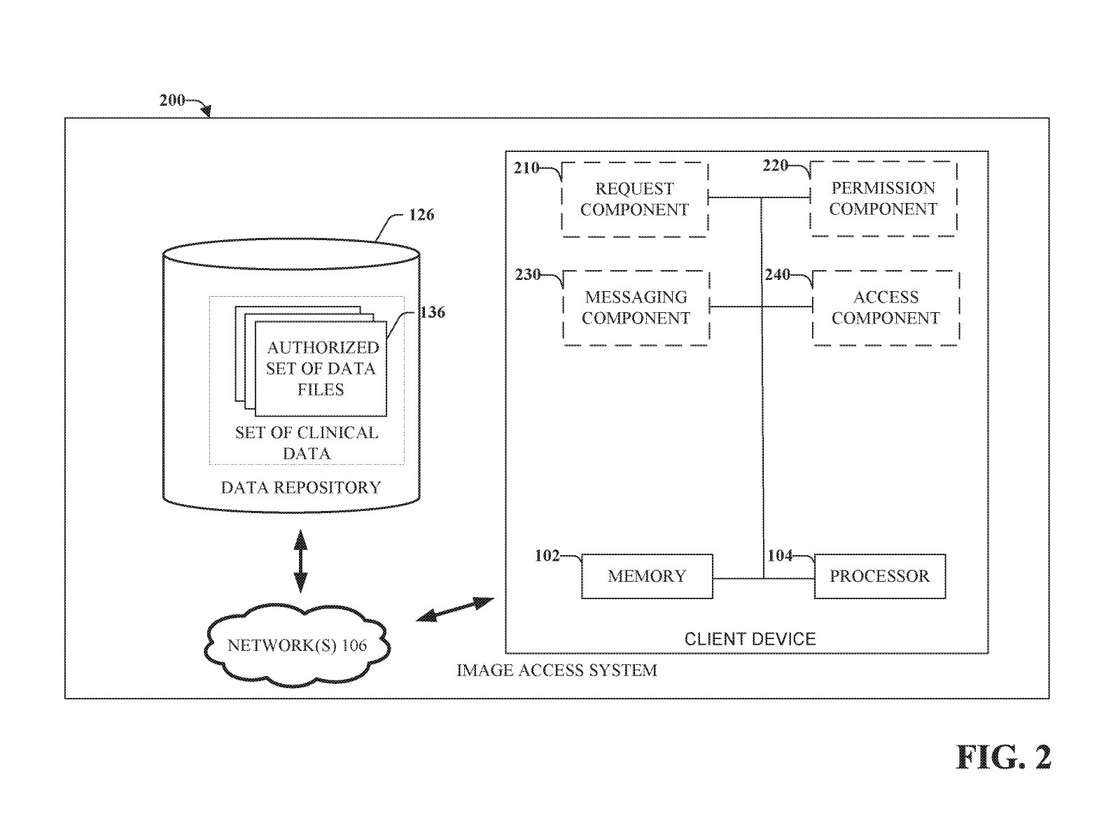

Referring now to the drawings, with reference initially to FIG. 2, system 200 is illustrated that facilitates the accessing, by an application executing on a user network device, of medical records by a user associated with the user network device. Aspects of systems, apparatuses or processes explained in this disclosure can constitute machine-executable component(s) embodied within machine(s), e.g., embodied in one or more computer readable mediums (or media) associated with one or more machines. In an aspect, system 200 includes memory 102 for storing computer executable components and instructions. A processor 104 can facilitate operation of the computer executable components and instructions by system 200.

The various components of system 200 can be connected either directly or via one or more network 106. Such network(s) can include wired and wireless networks, including but not limited to, a cellular network, a wide area network (WAN, e.g., the Internet), a local area network (LAN), or a personal area network (PAN). For example, messaging component 230 can communicate with data repository 126 (and vice versa) using virtually any desired wired or wireless technology, including, for example, cellular, WAN, wireless fidelity (Wi-Fi), Wi-Max, WLAN, and etc. In an aspect, one or more components of system 200 are configured to interact via disparate networks.

In an embodiment, system 200 employs a request component 210 that requests access, by a first device (e.g., an application executing on a mobile device), to a first authorized set of data files comprising a first authorized set of video files or a first authorized set of image files, wherein the data files are located at a data repository 126. In an aspect, system 200 comprises a tool that facilitates a patients' access to medical images. Typically, after a patient completes an imaging study, the images are shared with the patient via a copy of image prints or USB hard drive with image files or via CD. However, system 200 allows the patient to access the images via a mobile device application executing on the patients' device (e.g., mobile phone, tablet, computer, etc.).

The images are stored at data repository 126, however, only authorized data files 136 (e.g., video files, image files, etc.) are accessible to the first device (e.g., patients mobile device). An authorized data file are those medical images or clinical data approved for immediate access by a patient by the patients' provider (e.g., physician). For instance, a physician, may not wish to initially share all images with a patient and therefore may authorize some images for access via the application executed on a user device. An obstetrician, for instance, practices a form of medicine that faces many legal challenges and may wish to initially share only select images with the patient during the pregnancy.

As an example, a 20-week ultrasound study of a fetus performed by an Obstetrician, may reveal that the fetus is healthy and fine, however, a particular measurement may indicate the fetus is slightly smaller than average but still within the healthy range of standards as referenced by standard growth charts. The Obstetrician subsequently places an order and schedules an appointment with the patient to conduct another ultrasound between the 24-26-week fetal age. In order to mitigate the patient from incurring excessive worry and undergoing unnecessary concern, the Obstetrician may choose to wait to authorize the sharing of the ultrasound photo demonstrating the average but slightly small size of the fetus unless the patient specifically requests the specific image.

Thus, authorized medical images and unauthorized medical images are stored at data repository 126, however, the authorized images are accessible to the application executed on the patients' device (e.g., client device 106 or client device 108). The unauthorized medical images may be accessed by an authorized healthcare provider on the application executed on the healthcare providers network device. Prior to being accessed, by the application executing on a network device, the images (e.g., authorized and unauthorized) undergo a processing mechanism by which, images are undertaken (e.g., received by data repository 126 from various sources such as a providers local database), classified (e.g., by data, images, reports, other patient information), organized, compressed, and identified (e.g., images for sharing and images for storage without sharing) prior to being accessed and displayed by the application executed on the patients' network device. For instance, the images can be compressed and identified such that only particular characters can be placed in a message that is sent to the application executing on the user network device. The message can restrict certain images (e.g., unauthorized images) and allow other images (e.g., authorized images) to be shared with the application executing on a network device. The image preparation process allows a patient to access clinical data as needed on demand rather than requiring the patient to request the clinical data from the provider which may take time and significant effort.

In an aspect, the physicians or technicians can selectively choose, via electronic mechanisms, which images are shared with the patient application executing on a user network device. All the images (e.g., selected and unselected) are stored at database 126 (e.g., sometimes referred to as Historian Imaging). Once stored, the images requiring sharing (e.g., authorized images) are identified by the system. A link is prepared to share images to the appropriate channels and users (e.g., patient) such that the images to be shared with the user is are merged (e.g., by an application management services department) with a proprietary link for access by the application (e.g., sometimes referred to as HIR). For instance, images shared with a physician may be stored in a separate database (e.g., database other than data repository 126 or a partitioned space within data repository 126). The information shared with the physician can be accessed by a separate secure link either directly from a system archive (e.g., a unified archive platform that securely accesses all the structured and unstructured content stored in data repository 126 or another location) or from a local portal (e.g., a providers EMR).

In another aspect, system 200 employs permission component 220 that receives permission to access the first authorized set of data files based on a set of submitted information. In an aspect, the submitted information can be a social security number, a phone number, an address or other such personal identification information for verification and access to the medical images or clinical data. In another aspect, the submitted information can be an activation code, which is sent to the user (e.g., via e-mail, text message, electronic communication, etc.). The activation code can comprise a unique key sequence to enter into the mobile device keypad. In another aspect, the activation code can be an encoded message received by the user device which initiates automatic activation of the users account via the application executed on the user device.

In yet another aspect, the server sending the activation code and receiving the submitted information from the user network device (e.g., client device 112 or client device 110 illustrated in FIG. 1) can check to determine if the device is attempting to register for the first time. The user or patients network device will comprise a unique identifier (e.g., mobile phone number, e-mail address, IP address, etc.) to identify, verify, and communicate with the patient. The server can determine a first time registration identification by comparing the submitted information (e.g., activation code and associated phone number) that identifies the device with a list of comparable data (e.g., stored at a database) for previously registered devices. If the new device is deemed invalid, then the service is denied or if fraud is suspected then a registration routine for potential fraudulent devices can be administered to the mobile device.

System 200, in another aspect, employs a messaging component 230 that receives an embedded link within a message from a set of senders, wherein the embedded link comprises a customized bit pattern, a set of characters representing a personal health identifier and a set of data repository access information, and wherein the embedded link points to the first set of authorized data files at the data repository 126. In an aspect, the link is considered a Personal Health Identifier (PHI) or any information in the medical record of a patient or in a record set that was created, used, or disclosed in the course of providing a healthcare service such as diagnosis or treatment. The link is tied to a patient's clinical data (received from a provider) and is used to access the clinical data (e.g., medical images) stored at data repository 126. Also, the link is generated to include the information that links the key to the data repository 126 (e.g., database that stores the PHI).

Furthermore, in an aspect, messaging component 230 can receive an electronic message that comprises the embedded link (e.g., that links to clinical data such as medical images) in accordance with data formats corresponding to data interchange standards associated with the electronic message. System 200 can also send data (e.g., using request component 210) and information about whom (e.g., the patient, healthcare provider, etc.) is requesting to access the clinical data, why they need to access the data (e.g., for personal reasons, to share with family and friends, for clinical evaluation, etc.) and when the data is accessed (e.g., logging dates and times of users logging in, accessing the data, and logging out, etc.). The system 200 can be used by an authorized user (e.g., patient), authorized provider, and other users (e.g., family and friends) whom want to receive shared medical record data from the authorized user (e.g., patient can share medical images with family and friends whom have the application executing on their network device). The information can also be shared by a patient with any provider or any payer (e.g., including payer's attached to specific clearinghouse's and those not attached to a clearinghouse), and any vendor based on the patients' desire to share such medical images or medical records.

Furthermore, API server 114 (illustrated at FIG. 1) can be used to communicate data from identified libraries (e.g., provider databases, data repository 126, etc.) using various API calls by authorized users or user devices. For instance, the API server 114 can be designed for use with various programming languages to respond to commands and perform application functions. The API server 114 can facilitate use of libraries resident on various nodes in the networked system 100 environment. The API server 114 can be used to support both a runtime API or remote API's, wherein the runtime environment allows the full functionality user to use the application, and the remote environment of the remote API can facilitate use by a limited or remote user. In an aspect, the API server (e.g., or multiple API servers) can be linked to various libraries (e.g., authorized medical image library and unauthorized image library). The API server can properly map which library to access based on the network device requesting access and access credentials of such network device.

In another aspect, system 200, can facilitate access to a database of clinical data, which in an embodiment, the clinical data can be organized in various segments (e.g., by image categories, chronological dates, billing code, insurance claim code, etc.). The database can comprise the clinical data to support a specific request, wherein the clinical data may not be a complete clinical record but only that information necessary to justify the rationale for request (e.g., in compliance with the Minimum Necessary Rule). The Minimum Necessary Rule mandates that PHI should not be used or disclosed when it is not necessary to satisfy a particular purpose or carry out a function (e.g., a healthcare provider requesting medical data for treatment purposes). However, in an aspect, the application executed on the user device 112 allows access to the individual who is the subject of the information, which does not require application of the Minimum Necessary Rule. Thus, patients whom access their PHI via the application (e.g., as part of system 200), can freely access their medical images and share them with others (e.g., family, providers, insurers, etc.).

Furthermore, in an aspect, system 200 complies with Patient Disclosure Rules that require health information shared with healthcare professionals to remain confidential. The data associated with authorized and unauthorized medical images are not accessible except to the patients themselves (and authorized providers in instances). The data remains in the secure database 126 and is therefore confidential in accordance with Patient Disclosure Rules until the data is accessed and shared by a patient. Once accessed by the patient, the patient can do as they please with the data (e.g., share with other providers, family, friends, payers, other network devices executing the application, etc.).

In an aspect, the patient can access and share any personal health information (PHI) via the application in addition to images, such as clinical data that includes a body of information about the health status, the providing of health care, or the payment for health care associated with the patient. For example, a set of clinical data can comprise a patient's medical record, medical chart, documentation (e.g., of drugs administered, therapies or treatments rendered, test results, x-rays, reports, etc.), notes, recordings, and so on. Any single patient may have numerous PHI (e.g., links) associated with the set of clinical data and numerous sets of clinical data associated with numerous PHI and patients can be stored at the data repository 126 (or other databases).

In another aspect, messaging component 230 receives a link embedded within a message, where the link comprises a set of characters representing the personal health identifier corresponding to a first subset of clinical data of the set of clinical data, wherein the generating the link is based on a phone number (e.g., a phone number of the patient) associated with the personal health identifier, and wherein the first subset of clinical data represents a set of clinical information corresponding to the phone number. In an aspect, the embedded link (e.g., received using messaging component 230) can be associated with coded data, encrypted data, or de-identified data such that the data (e.g., sets of images, sets of clinical data, subsets of clinical data, a first subset of clinical data, etc.) can be considered indirectly identifiable.

In an aspect, the embedded link is a bridge to clinical data (e.g., medical images) associated with a patient. The embedded link can comprise a set of characters (e.g., capital letters, numbers, periods, etc.). The link can take into account the requirements and standards (e.g., standards set forth by ASC X12 such as X12 EDI, CICA standards, XML schemas, HL7, Standards and Interoperability, etc.) of various data architectures and messaging architectures within various industries (e.g., healthcare, insurance, finance, etc.) such that the link is capable of being embedded within respective messaging architectures. For example, in an instance the link can be embedded within an ANSI ASC X12 837 message, such that the link comprises a combination of one or more capital letter, number, and period in various permutations, combinations, and orders acceptable to ANSI X12 837 system requirements and messaging formats.

In yet another aspect, the set of clinical data is a body of medical information such as a set of ultrasound images associated with respective patients. In an embodiment, the set of clinical data can comprise billing codes, codes that describe particular diagnoses, procedures, drugs, operations, electronical medical records (EMR), claim data, medical notes, or any other data associated with a patient and their interactions with health care providers (e.g., receiving services and products), and clinical information. In an aspect, a subset of clinical data is a portion of a patients set of data organized in a particular manner for a particular purpose. Thus a subset of clinical data can be organized in a particular chronology (e.g., ultrasound images of fetal development from early weeks to later weeks, imaging related to cure of an illness such as reduction in tumors as per a CAT scan over a course of cancer treatment, etc.).

In another embodiment, as a user (e.g., patient) clicks on the link to view the authorized images, the user may have to provide various information such as whom is requesting to access the data and why they seek to access the data. In an aspect, the application server 118 (e.g., using data file application 122 or social application 120) collects this descriptive information and is capable of logging as well as tracking such information. In an aspect, the API server 114 can facilitate the identification of persons or classes of persons who are requesting access (e.g., using request component 110) to the authorized set of data files. Furthermore, for such clinical data that a person requires access, application server 118 can facilitate a determination as to whether access to such data is needed and the conditions contributing to such access are appropriate to grant such access. The logging, tracking, and collecting features of the application server 118 along with the providing of reasonable efforts to limit access to clinical data contributes towards the satisfaction of the requirements of the Minimum Necessary Rule.

In another aspect, messaging component 230 can receive the message with embedded link through a first EMR system, a second EMR system, a customized hospital system, a Health Information Exchange System or generally through numerous software systems. The message and the link (as well as link location) is capable of passing the edits of each system. In an aspect, the standard, used in connection with the message (comprising the embedded link), provides rules that allow for a limited set of characters to be provided in a link. The standard limits the use of certain characters because a message often passes through intermediaries (e.g., various provider systems) prior to arriving to the client device 112 (e.g., via the application executing on the client device 112).

As such, the link embedded within a message must be compatible with the systems it passes through. Therefore, the message is able to pass through the providers system and any intermediate system that receives the message along the journey from the provider to the client device 112. The standards of all such systems have in common the allowability of particular bit patterns associated with the link. The disclosed subject matter includes the one or more bit patterns allowable by all the systems and standards associated with such systems to allow the message embedded with a link to be transmitted to each system. The disclosed subject matter includes bit patterns used universally by all systems (and software) and provides for a schema that allows a message with embedded link to travel via systems without being restricted as a message utilizing a limited bit pattern.

As a non-limiting example, a link embedded within a message may be sent from provider A using system 1 to intermediary B using system 1, from intermediary B to intermediary C using system 2, from intermediary C to intermediary D using system 3, from intermediary D to client device 112 or client device 110 using system 3. In such instance, the link can utilize a bit pattern or subset of bit patterns that are compatible with system 1, 2 and 3 to allow the message with embedded link to be accessible at each location of provider A, intermediary B, intermediary C, intermediary D and client device 112 or client device 110. In an aspect, the embedded link comprises only the bit pattern allowable by the systems of the provider, intermediaries, and user network devices.

The embedded link also comprises a location code for routing a key to the specific clinical data subsets (e.g., authorized images). A data repository 126 (comprising both authorized images and unauthorized images (or a separate database storing each classification of image), will require use of a key to access the relevant data for the patient or provider. The data is located behind a firewall (e.g., the providers firewall), the key to access the particular data subset will only be effective behind such firewall. Thus the key has to be interpreted at two locations to be useful (e.g., at the location of the authorized client device 112 and at the location of the data, such as behind a provider's firewall). In an aspect, the embedded link may comprise numerous keys to facilitate access to particular data at different locations in accordance with target data for viewing.

Furthermore, in an aspect, the link embedded within the message contains a location for routing. When a user (e.g., client device 112) utilizes the link (e.g., clicks on the link), the disclosed system derives the location of the storage of the data (e.g., data repository 126, disparate data locations, etc.). The disclosed subject matter allows for the request to access data (e.g., using request component 110) and for the networked device to be routed to data repository 126 (e.g., a hospital system may have a separate data repository 126 for each of its many hospitals under its umbrella) or other such database depending on the data sought and the location of the data (e.g., images stored in the data repository 126, clinical data stored at a hospital database, etc.). For instance, in an aspect, a link embedded in a message can potentially have numerous end points corresponding to various locations of stored data. For example, a link can have location A, B, and C as endpoint locations of the link, where each endpoint leads to a separate subset of data points.

In another aspect, request component 110 also allows for the sending of descriptive information to provide a layer of security before access is granted to the client device 112 (e.g., using access component 120) attempting to access the clinical data. The message and embedded link can be received by client device 112 or authorized users (e.g., hospital provider, physician, etc.) in various formats (e.g., ANSI 837-5010, ANSI 835-5010, etc.). The message can be utilized in a range of EDI environments, by which, standards have been developed and implemented by organizations within the health care industries. For instance, a hospital provider can receive an embedded link from another hospital provider to assist with a patient's continuity of care.

In an aspect, system 200 can also facilitate the sending of the message with embedded link or a PDF with embedded link to an EMR system of a provider. The images can be stored in the provider's EMR and can be recalled on-demand with the exact same quality of image as at the time of image processing. A provider can request an image through the link, the application server 118 then retrieves the image from a secure long-term storage facility (e.g., data repository 126) and directs the results back to the provider's web client 106 or server 130. In an aspect, a provider can share images using the application servers 118 by sending a direct message to another provider. A direct message abides by the standards, rules, and policies associated with operation of the security and trust layer in messaging between health providers. The direct messages can be captured by the application servers 118 and an embedded link and PDF can be generated (e.g., using application server 118) to send to a third party server 130 (e.g., provider server) using the third party application 128 (e.g., EMR system). In an aspect, the provider can view the images and are able to share the image with another provider using direct messaging.

The feature of receiving a message (e.g., using messaging component 230) comprising an embedded link to a limited subset of clinical data (e.g., medical images) provides significant time efficiencies, cost savings, organizational efficiencies, and practical access to medical records. Furthermore, because additional security and access restrictions will be in place, the clinical data will only be accessed by those requiring access (e.g., the patient, healthcare provider, etc.). For instance, the clinical data and information never transfers to a patient or provider until accessed and downloaded, but instead the clinical data remains at data repository 126 (also referred to as a data store), which can sit behind a protected firewall (e.g., behind a provider firewall). This allows the secure data repository 126 to have complete control over the clinical data at all times.

Furthermore, a key may be required to access the clinical data as well. The key may be utilized by a provider certificate or hospital certificate to access the clinical data. Thus a provider may send the link (e.g., using messaging component 230) with the information (e.g., provider certificate) that links the key to the data repository 126 (or numerous data repositories). In another aspect, the provider can receive the link (e.g., using messaging component 230). In an aspect, the data repository 126 can be employed to store information (e.g., sets of clinical data) local to the provider as well.

System 200, in another aspect, employs an access component 240 that accesses the first authorized set of data files via the embedded link. In an aspect, a network device (e.g., user mobile phone or tablet) can access the authorized set of data files (e.g., images approved for sharing with a patient) by clicking on the embedded link in the message. The link will point the device to the location of the authorized files (e.g., at data repository 126 or other such database). In another aspect, a network device (e.g., provider device) can access the unauthorized st of data files with the proper verification processes (e.g., providing identification information and a key). Furthermore, in an aspect, once the files are accessed via the link, the network device (e.g., client device 110 or client device 112) can view, share (e.g., with family and friends if the patient), and store locally (e.g., on the network device) the medical data.

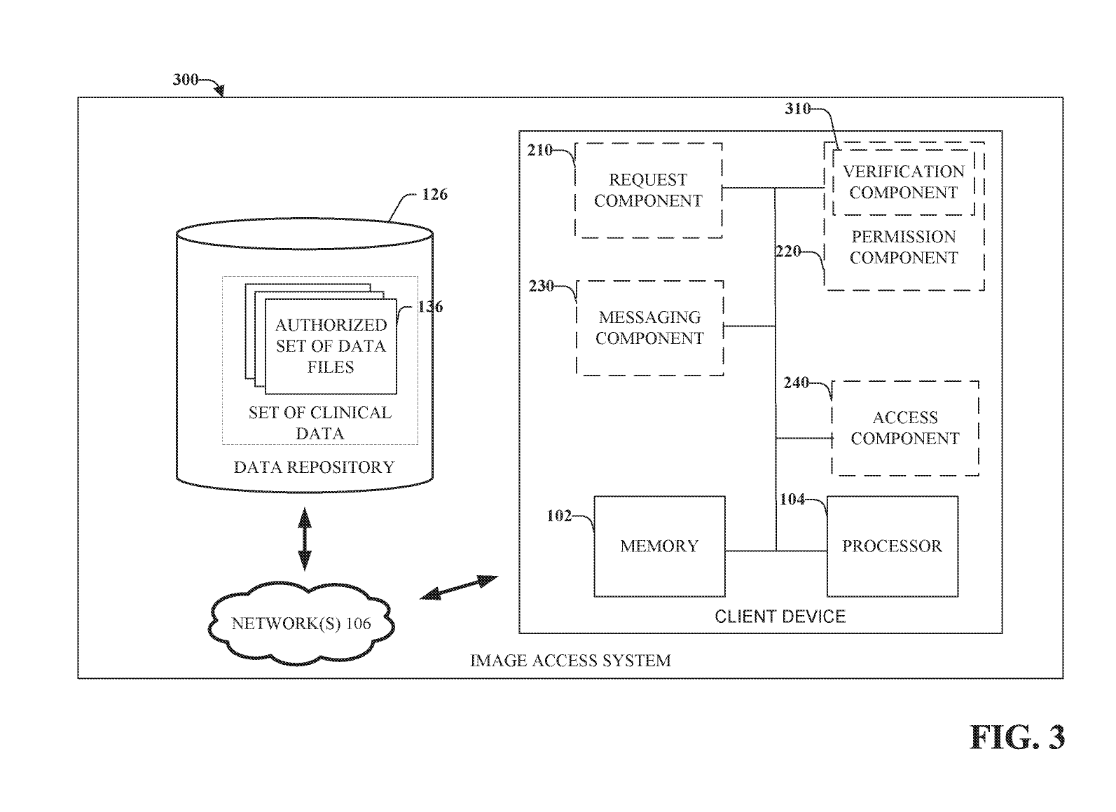

Turning now to FIG. 3, presented is another non-limiting embodiment of system 300 that provides access to medical records using an application executing on a network device. In an aspect, system 300 can comprise the permission component 220 that employs a verification component 310 that verifies that the application executing on the first device is authorized to access the first authorized set of data files based on a first identifier associated with the first device. In an aspect, the application executing on the first device accesses an identifier stored on the first device to verify (e.g., using verification component 310) the authority of the first device to access the medical data. For instance, after the device is identified as being associated with a particular user (e.g., via phone number), a password (to access the application executing on the first device) and a proprietary cryptographic nonce is saved to the network device.

Furthermore, each time the first device launches the application (e.g., logs into the application), the password is securely reset such that old communication via the application cannot be re-used to access data, re-transmit data, and perform other fraudulent tasks related to the data and application. Thus the channels by which the data is transmitted make use of cryptographic techniques to make sure the password required to access the application and corresponding data is encrypted before it's transmitted over the communication stream. Therefore, the system is designed to provide a level of assurance that the password can only be decrypted by a particular device used by an authorized user.

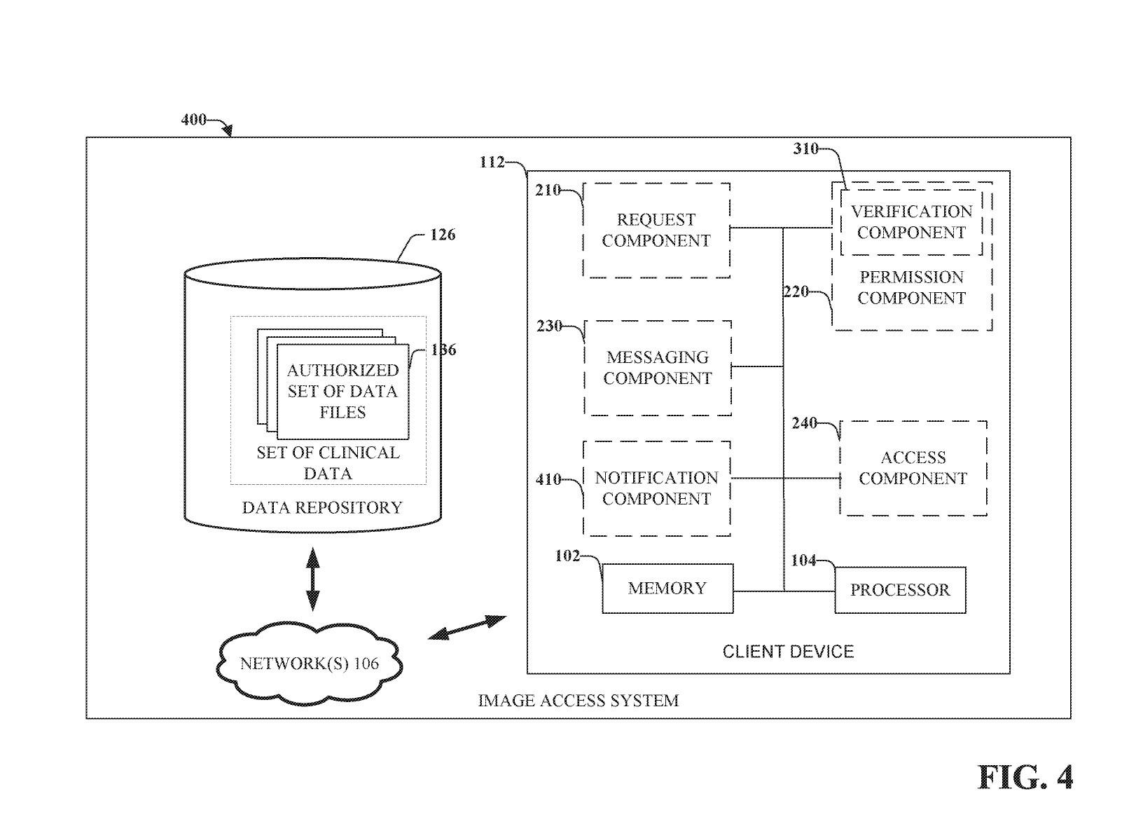

Turning now to FIG. 4, presented is another non-limiting embodiment of system 400 that provides access to medical records using an application executing on a network device. In an aspect, system 400 can comprise the components disclosed in system 300. Furthermore, system 300 can further comprise notification component 410 that provides a notification that a message or data file of the first authorized set of data files is received or sent. For instance, notification component 410 can alert the network device that there is an incoming message or that an outgoing message has been successfully or unsuccessfully sent. The notification function can include an audible sound (e.g., ringing), a physical response (e.g., constant or intermittent vibration), a message (e.g., text message notification, etc.), and other such forms of notification.

The notification function can occur in connection with various tasks performed by the application executing on the network device. Thus, if another network device (e.g., family member using the application executing on their network device) seeks to connect with the application executing on the patients network device then a notification (e.g., using notification component 310) can alert the patients network device. As such, the notifications can be tied to incoming or outgoing messages, connecting with users, attempts to access data, application updates, news updates, and other such application tasks.

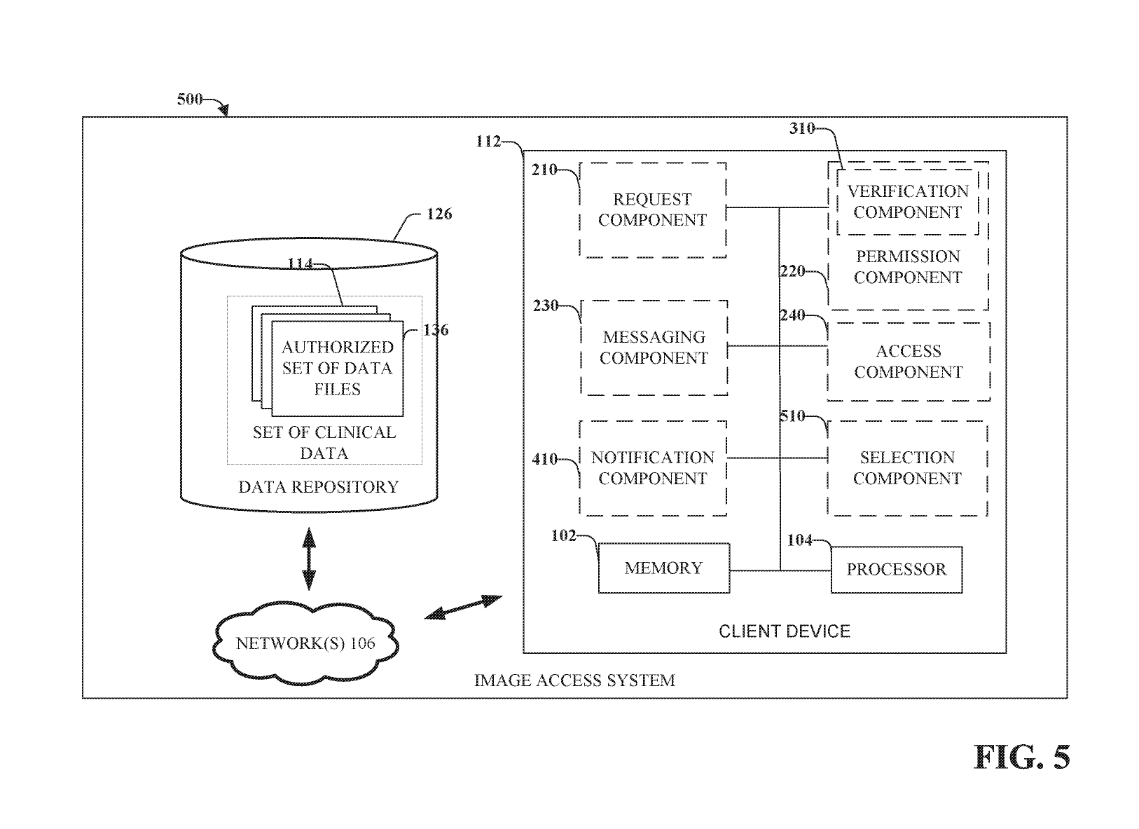

Turning now to FIG. 5, presented is another non-limiting embodiment of system 500 that provides access to medical records using an application executing on a network device. In an aspect, system 500 can comprise the components disclosed in system 400. Furthermore, system 500 can further comprise a selection component 510 that selects the first authorized set of data files, via the application executing on a third device, from a set of data files comprising the first authorized set of data files and a set of unauthorized data files 138. In an aspect, a patients physician can authorize the set of data files for patient access and viewing using the application. A physician may not desire to provide access to all images or all data immediately.

Thus, the physician can use the application executing on a third device (e.g., provider tablet or mobile device) or using a system that integrates with the application (e.g., provider EMR portal) in order to select (e.g., using selection component 510) the authorized images or data for selection. In another aspect, the images selected (e.g., using selection component 510) for viewing and authorized users (e.g., patient) can be stored at data repository 126 or a separate database for access by the user. The images that are not selected or marked as unauthorized can be stored at data repository 126 or a database separate from the authorized images. Thus the unauthorized images can be inaccessible via the application to the patient.

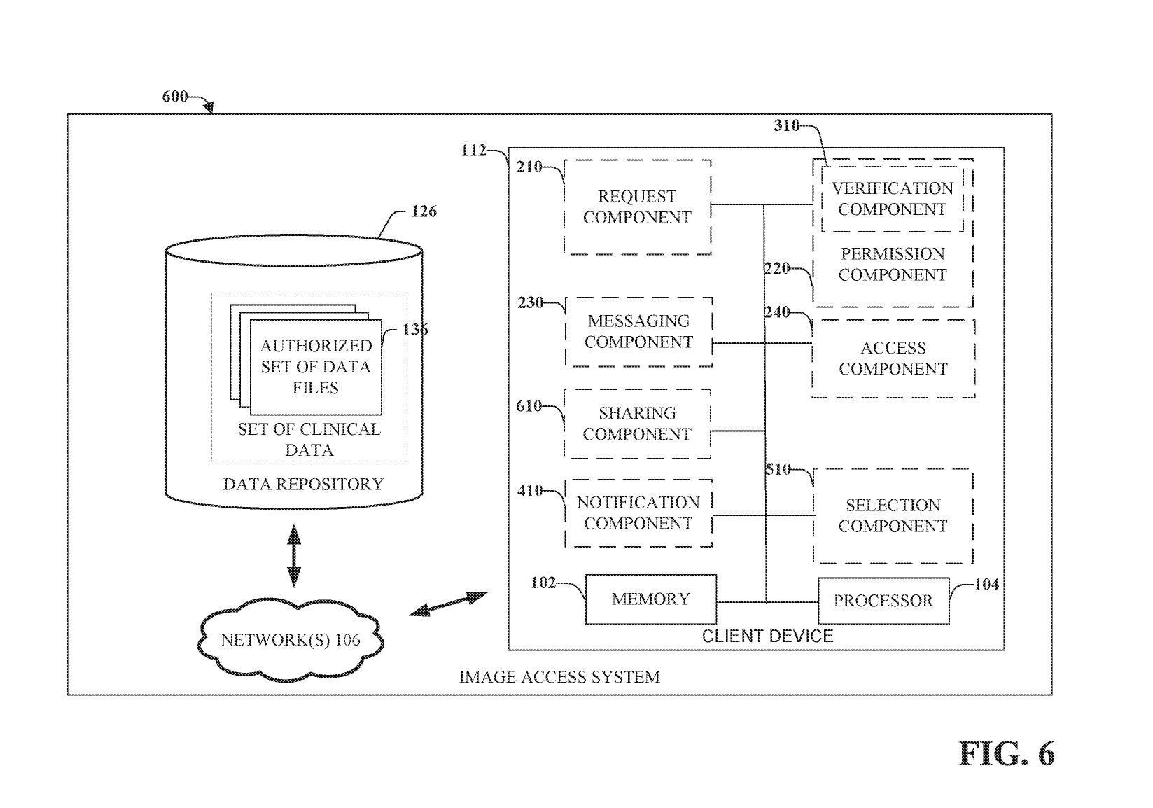

Turning now to FIG. 6, presented is another non-limiting embodiment of system 600 that provides access to medical records using an application executing on a network device. In an aspect, system 600 can comprise the components disclosed in system 500. Furthermore, system 600 can further comprise a sharing component 610 that shares a subset of authorized data files of the first authorized set of data files with the application executing on a second network device based on a second identifier associated with the second network device. In an aspect, the application executing on a first device (e.g., patient's mobile device) can share content to any available social network outlet (e.g., social networking sites, labor networking sites, social circles, image sharing sites, etc.). The user can share the image as they would any image from the photo library store locally or at a remote location via the mobile device.

In another aspect, the user can share content with other application users (e.g., the application executing on other user and network devices) by using an inter-share button. Thus, the application (e.g., using social application 120) can facilitate the sharing of medical images and other authorized data with social users of the application. The user can simply type into the application executing on the mobile device, the recipient's phone number (e.g., identifier of the recipients mobile device) and the user of the application on the second network device (e.g., family member, friend) or third network device (e.g., healthcare provider) will be notified (e.g., using notification component 410) that an image of data has been shared with their respective device. If the identifier such as phone number does not associate with an existing user, then the user associated with the sent phone number will be invited (e.g., via e-mail or text) to create an account using an activation code, so they may view the image.

Furthermore, in an aspect, a patient-user of the application can share content with providers using a Direct Message protocol. The Direct Message protocol is an internet standard, used by organizations and overseen by a government body, that validates and manages secure message services to physicians and providers within the United States. The application allows users to send messages to providers using an inter-HIR share button. A user merely need type a provider's direct address (e.g., provider's first and last name) into the application (e.g., using the application interface) and the application verifies the direct address with a registry from Direct Trust (a provider that maintains the provider database). Upon verification, the image or medical data is sent to the provider (e.g., a provider having a Direct Trust address). The user can alternatively send the message securely via inter-device sharing using the application executing on each respective device (e.g., provider-device and user-device).

In yet another aspect, the application can make use of health data collected by various devices (e.g., fitness bands, health tracking applications, etc.) and share such information with the patient-user. Furthermore, the patient-user can share this information with providers, the payer community and wellness organizations via the application. Thus, the application can serve as a one-stop shop comprehensive medical data and health data storage and sharing mechanism between patients, providers and payers. Providers and hospitals can engage patients in a more meaningful, open, and detailed manner, while also maintaining the ability to share images with other providers using the application. Furthermore, the provider can utilize the application as a reliable backup and disaster recovery tool for data.

As a non-limiting example embodiment, a user can download the application to the user-mobile device, enter the activation code and submit any additional requested information. The user can then use the application, by clicking a link sent to the mobile device via electronic message to access medical records and images. The images can then be shared (e.g., from a list of files or from a viewing interface) using the application with any users stored in the mobile device (e.g., using a share extension). The user can use the application to share any medical record of themselves or within their immediate application network to any other application user by sharing the record to a new user or existing user (e.g., by entering the recipients mobile phone number).

Existing users can be notified by the application that a new medical record has been shared with them and if it's the first time sending to the particular user, the recipient-user can be added to a shared list (e.g., social circle). A new user can be notified (e.g., receiving a welcome text notification with activation code) to download the application and enter the activation code messaged to the new users' device. The message can indicate that new medical content is available to download. Furthermore, the patient-user can share any of their own medical record to any healthcare provider within their health network using the Direct Trust network and by entering the provider's Direct Address.

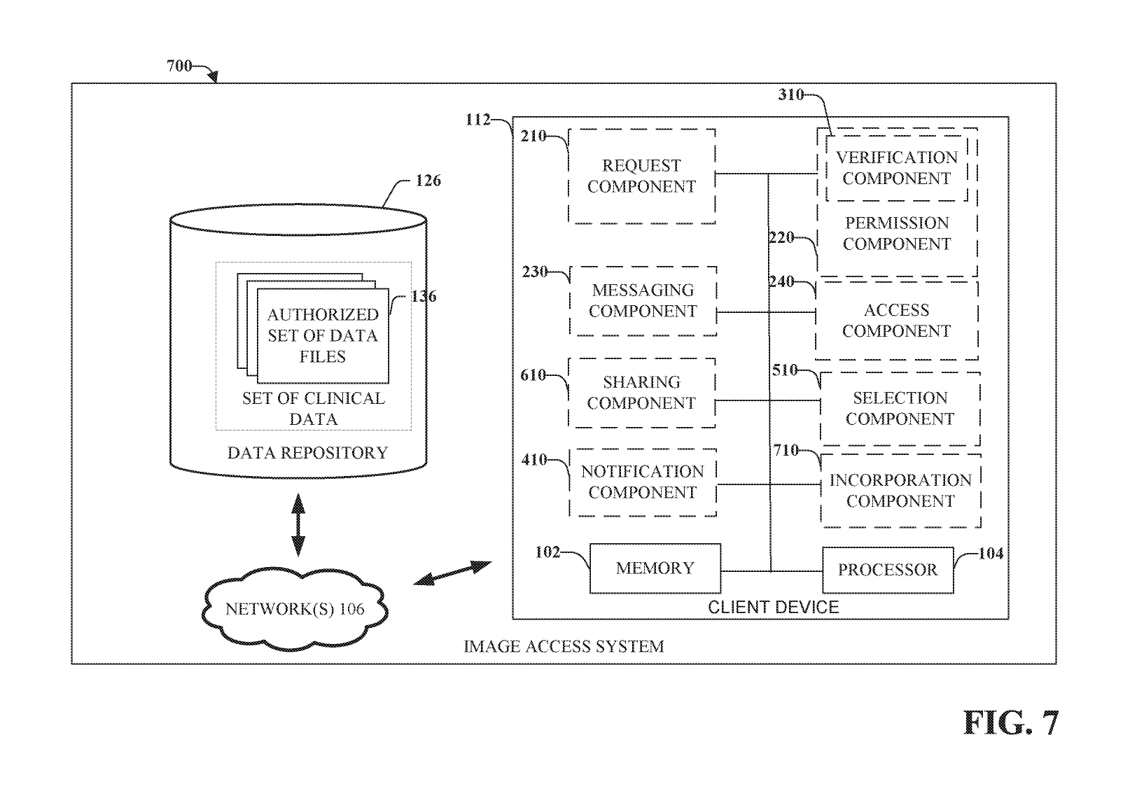

Turning now to FIG. 7, presented is another non-limiting embodiment of system 700 that provides access to medical records using an application executing on a network device. In an aspect, system 700 can comprise the components disclosed in system 600. Furthermore, system 700 can further comprise an incorporation component 710 that facilitates the incorporation, by the application executing on the first device, of a second authorized set of data files to the first authorized set of data files. The application can serve as a tool for the sharing of many images besides medical images.

As such, a user can utilize the application executing on the first device to share and incorporate (e.g., using incorporation component 710) other images (e.g., medical and non-medical images) to the authorized set of files. In an aspect, an existing user can append new medical content to their application profile. Furthermore, a new user can incorporate medical content to a new profile. Thus additional files can be stored in a separate database (e.g., data repository 126 or other database) with additional or newly added images.

For instance, family photographs, newborn photos, ultrasound images, images and videos stored on patient devices, images and videos stored on family member devices can all be incorporated into authorized images for accessing, viewing, and sharing. Thus the patients can catalogue images they want for use on the platform application. The application serves as a mechanism to manage patients medical histories, medical records and medical images where the patient controls such data.

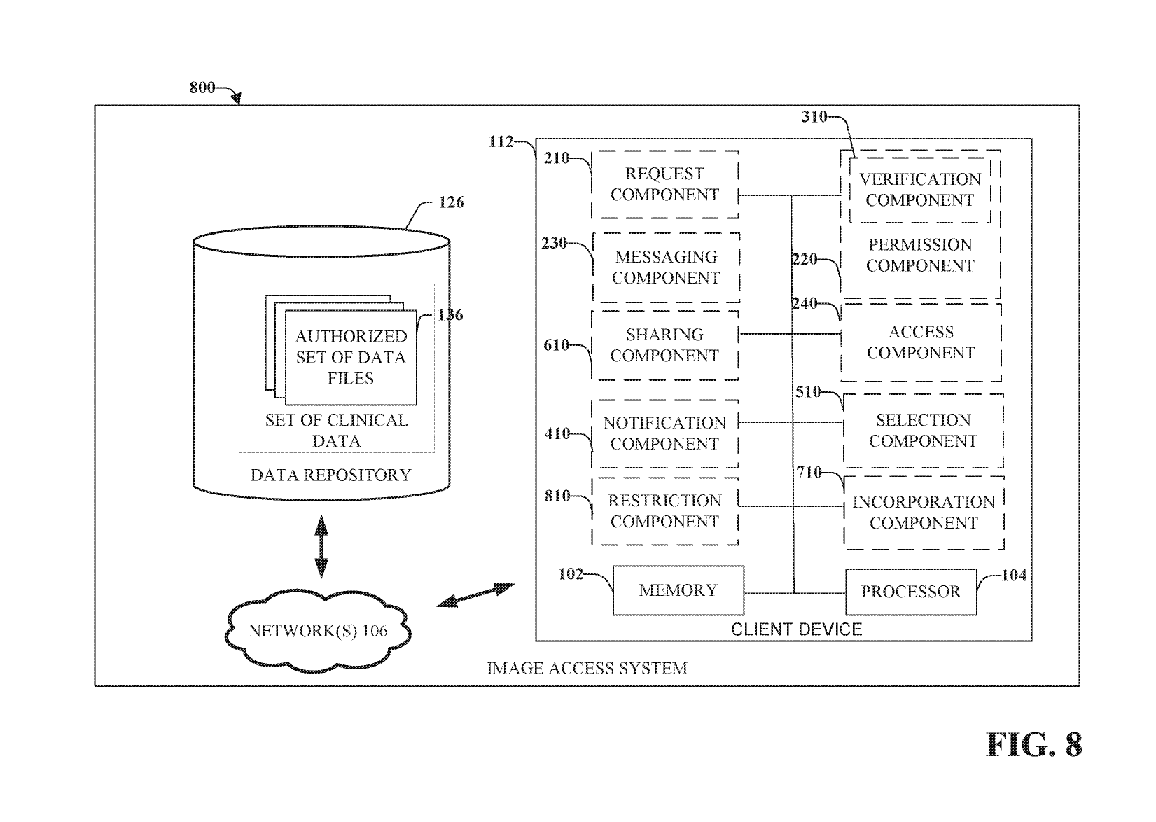

Turning now to FIG. 8, presented is another non-limiting embodiment of system 800 that provides access to medical records using an application executing on a network device. In an aspect, system 800 can comprise the components disclosed in system 700. Furthermore, system 800 can further comprise restriction component 810 that restricts the application executing on the second device from sharing the first authorized set of data files.

In another aspect, a user can share images via the application executing on the first device, but limit the ability of the other party (e.g., recipient of the shared image) from sharing the image further with other users. As such, a patient-user can control the sharing of images and keep images private between a select few users. Conversely, the user can also share images via the application and allow others to share the image as well with others in their network or outside their network.

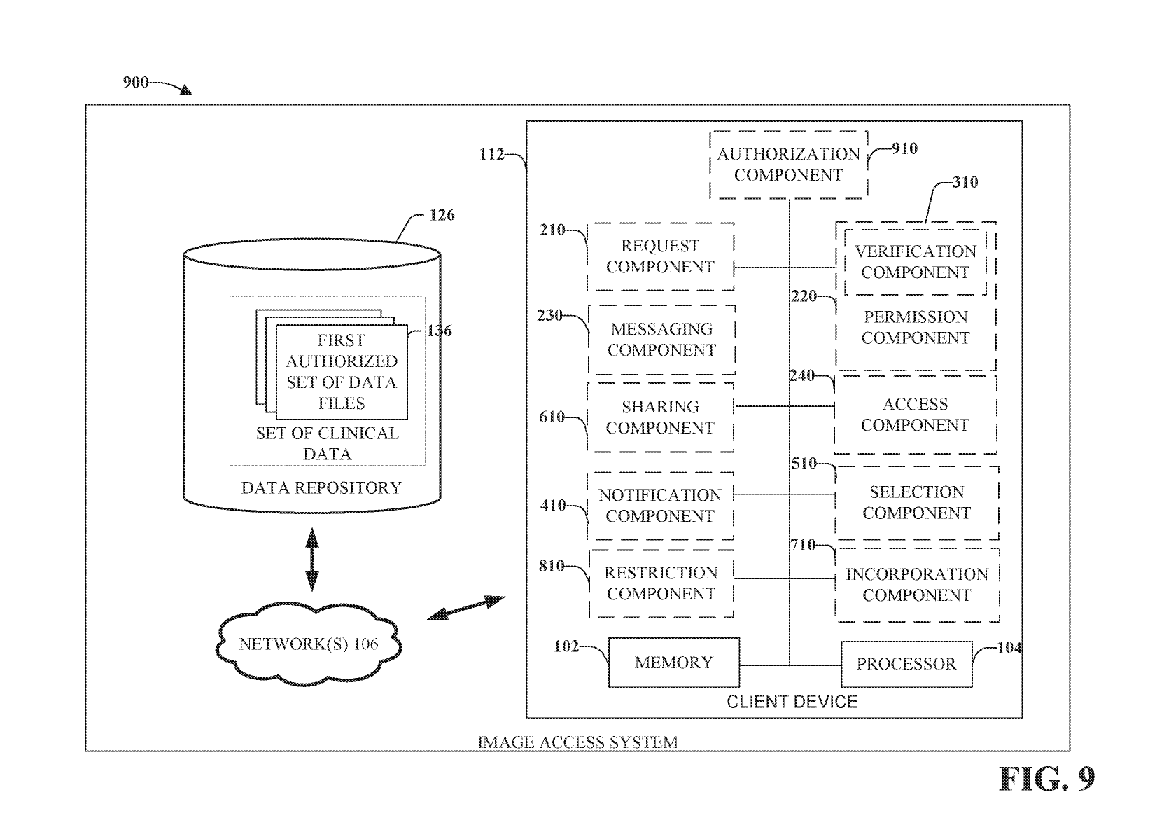

Turning now to FIG. 9, presented is another non-limiting embodiment of system 900 that provides access to medical records using an application executing on a network device. In an aspect, system 900 can comprise the components disclosed in system 800. Furthermore, system 900 can further comprise authorization component 910 that facilities a granting of permission, by the first device, to a fourth device to share the first authorized set of data files with a fifth device. In an aspect, a patient-user of the application executing on a first device can grant permission to a provider-user of the application executing on a fourth device (e.g., provider A's device) to provide patient data to the application executing on a fifth device (e.g., provider B's device). Thus a patient can allow providers to use the application to send patient data between one another.

Thus, the application simplifies the transactional needs of inter-provider communication, while following all the regulatory requirements. The application allows physicians, pharmacists, paramedics, hospitals, drug manufacturers, dentists, health insurance providers, optometrists, and other entities within the health care system to retrieve patient data in an easier manner and from the patient themselves or from an authorized user. Therefore, the process of gathering and sharing medical data is simplified and reduces physical paperwork by using the application. Through inter-provider sharing and empowering the patient to easily facilitate sharing of medical data themselves, the application allows for a breakthrough in the transfer of medical data. The patient is empowered by taking control over their own medical data and providing it to health providers, payers, family, friends, and social circles.

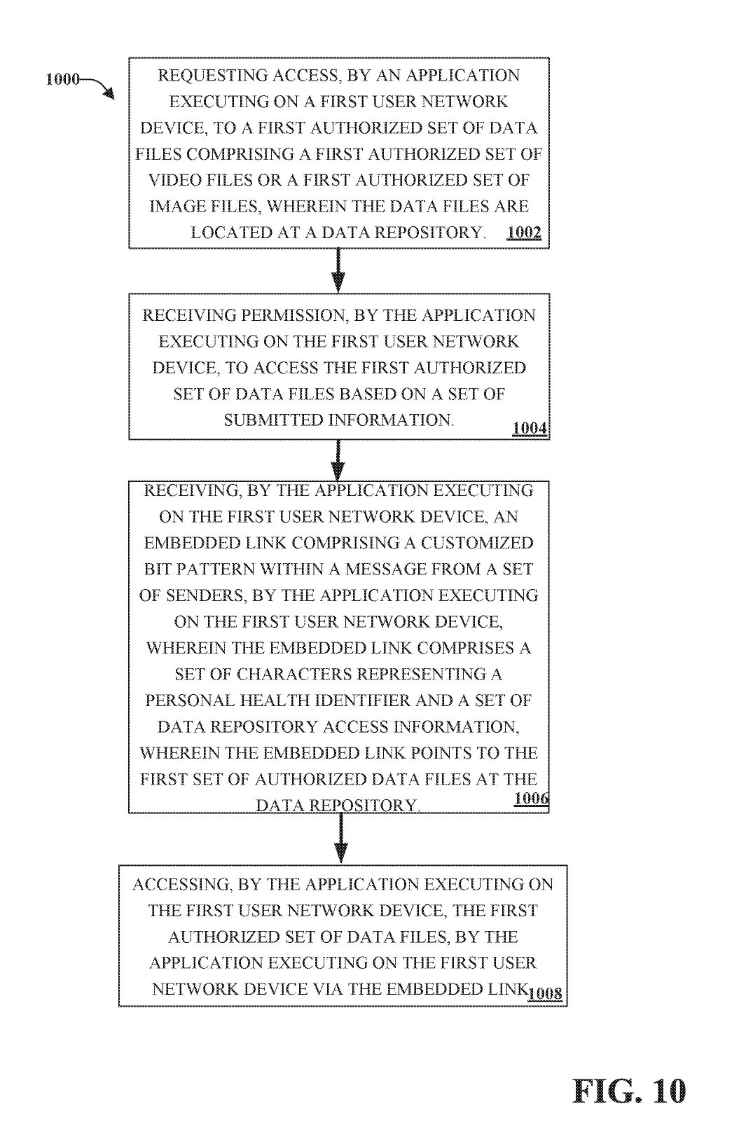

In view of the example systems and/or devices described herein, example methods that can be implemented in accordance with the disclosed subject matter can be further appreciated with reference to flowcharts in FIGS. 10-14. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein.

For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 10 illustrates a flow chart of an example method 1000 for accessing medical records using an application executing on a network device. At 1002, an application execution on a first user network device, requests (e.g., using request component 210) access to a first authorized set of data files comprising a first authorized set of video files or a first authorized set of image files, wherein the data files are located at a data repository 126. At 1004, the application executing on the first user network device receives permission receives permission (e.g., using permission component 220) to access the first authorized set of data files based on a set of submitted information.

At 1006, the application executing on the first user network device receives an embedded link comprising a customized bit pattern within a claim message from a set of senders, wherein the embedded link comprises a set of characters representing a personal health identifier and a set of data repository access information, wherein the embedded link points to the first set of authorized data files at the data repository. At 1008, the application executing on the first user network device accesses the first authorized set of data files using the embedded link.

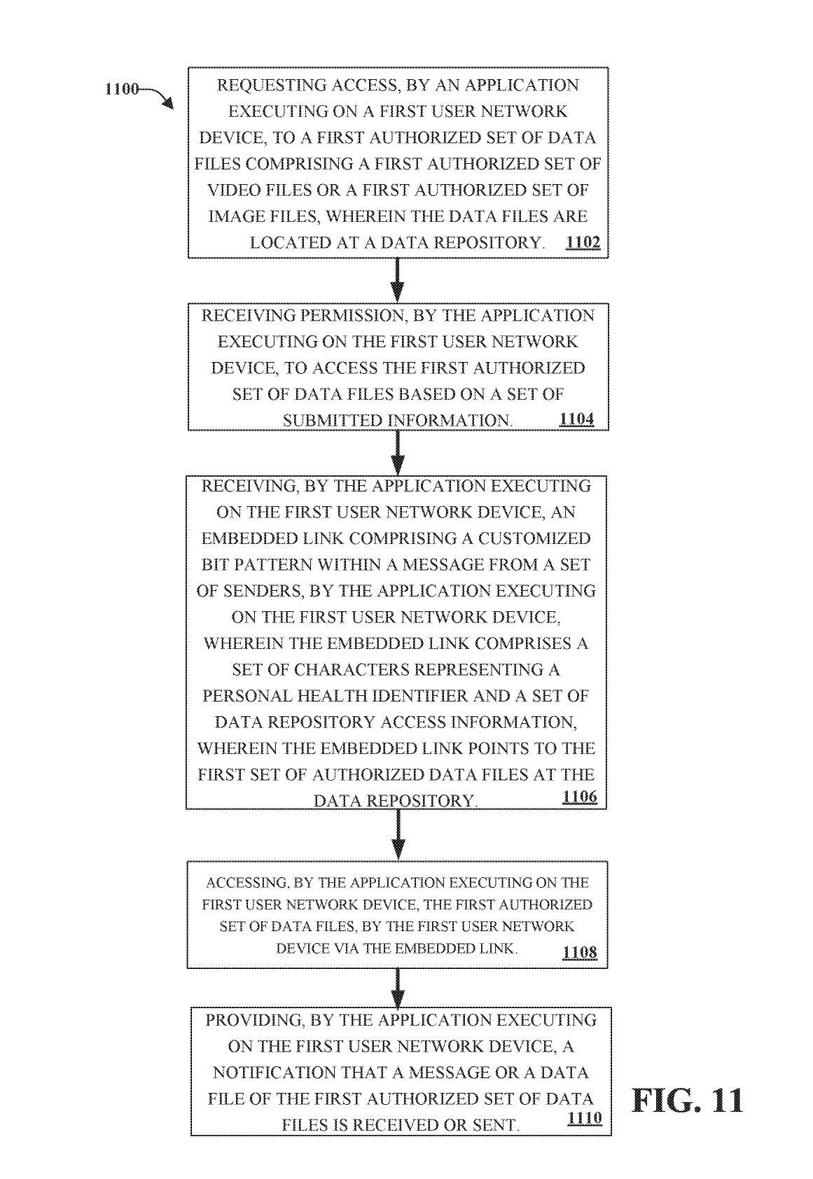

FIG. 11 illustrates a flow chart of an example method 1100 for accessing medical records using an application executing on a network device. At 1102, an application execution on a first user network device, requests (e.g., using request component 210) access to a first authorized set of data files comprising a first authorized set of video files or a first authorized set of image files, wherein the data files are located at a data repository 126. At 1104, the application executing on the first user network device receives permission receives permission (e.g., using permission component 220) to access the first authorized set of data files based on a set of submitted information.

At 1106, the application executing on the first user network device receives an embedded link comprising a customized bit pattern within a claim message from a set of senders, wherein the embedded link comprises a set of characters representing a personal health identifier and a set of data repository access information, wherein the embedded link points to the first set of authorized data files at the data repository. At 1108, the application executing on the first user network device accesses the first authorized set of data files using the embedded link. At 1110, the application executing on the first user network device, provides a notification (e.g., using notification component 410) that a message or a data file of the first authorized set of data files is received or sent.

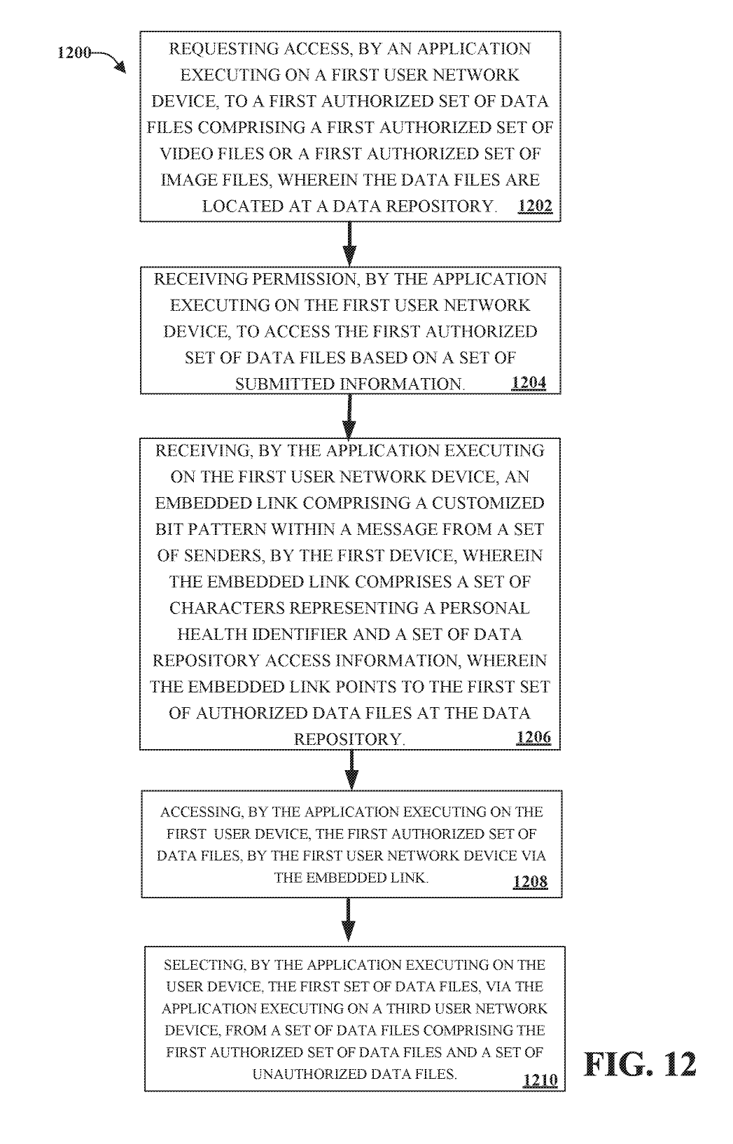

FIG. 12 illustrates a flow chart of an example method 1200 for accessing medical records using an application executing on a network device. At 1202, an application execution on a first user network device, requests (e.g., using request component 210) access to a first authorized set of data files comprising a first authorized set of video files or a first authorized set of image files, wherein the data files are located at a data repository 126. At 1204, the application executing on the first user network device receives permission receives permission (e.g., using permission component 220) to access the first authorized set of data files based on a set of submitted information.

At 1206, the application executing on the first user network device receives an embedded link comprising a customized bit pattern within a claim message from a set of senders, wherein the embedded link comprises a set of characters representing a personal health identifier and a set of data repository access information, wherein the embedded link points to the first set of authorized data files at the data repository. At 1208, the application executing on the first user network device accesses the first authorized set of data files using the embedded link. At 1210, the application executing on the first user network device selects (e.g., using selection component 510) the first set of data files, via the application executing on a third user network device, from a set of data files comprising the first authorized set of data files and a set of unauthorized data files.

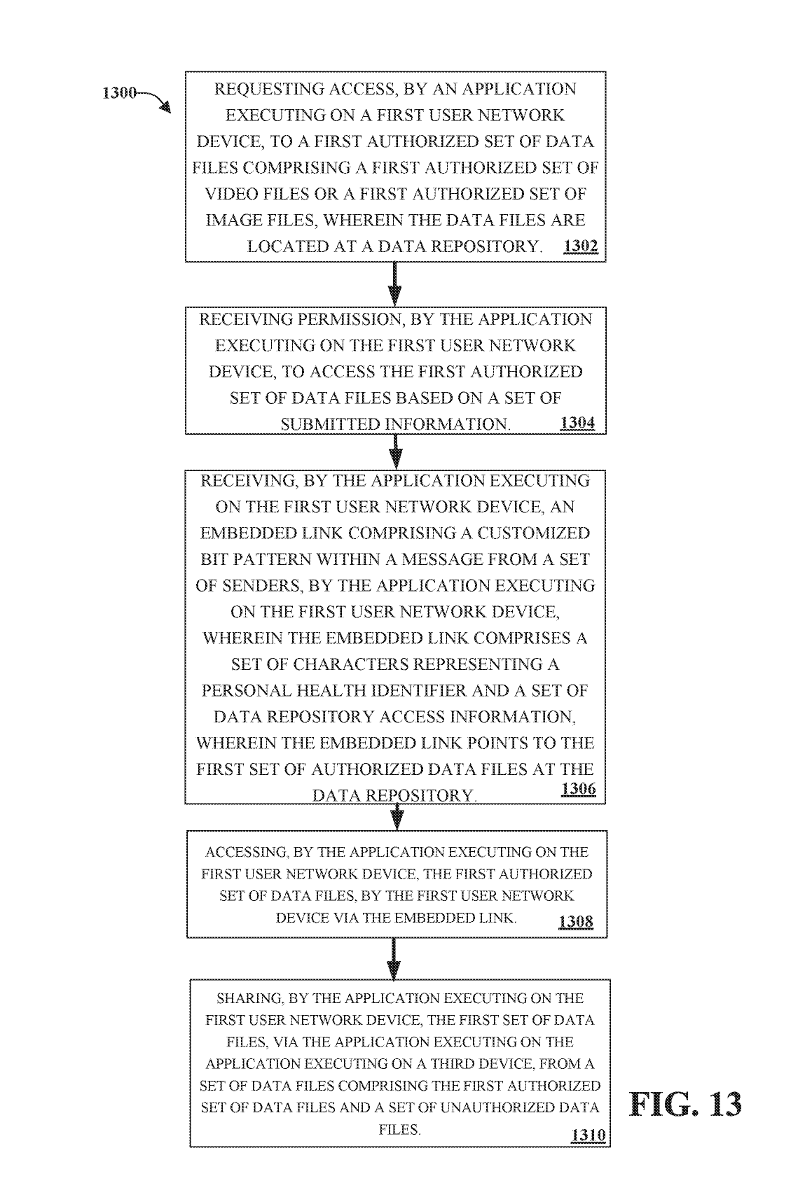

FIG. 13 illustrates a flow chart of an example method 1300 for accessing medical records using an application executing on a network device. At 1302, an application execution on a first user network device, requests (e.g., using request component 210) access to a first authorized set of data files comprising a first authorized set of video files or a first authorized set of image files, wherein the data files are located at a data repository 126. At 1304, the application executing on the first user network device receives permission (e.g., using permission component 220) to access the first authorized set of data files based on a set of submitted information.

At 1306, the application executing on the first user network device receives an embedded link comprising a customized bit pattern within a claim message from a set of senders, wherein the embedded link comprises a set of characters representing a personal health identifier and a set of data repository access information, wherein the embedded link points to the first set of authorized data files at the data repository. At 1308, the application executing on the first user network device accesses the first authorized set of data files using the embedded link. At 1310, the application executing on the first user network device shares (e.g., using sharing component 610) a subset of authorized data files of the first authorized set of data files with the application executing on the second user network device based on a second identifier associated with the second user network device.

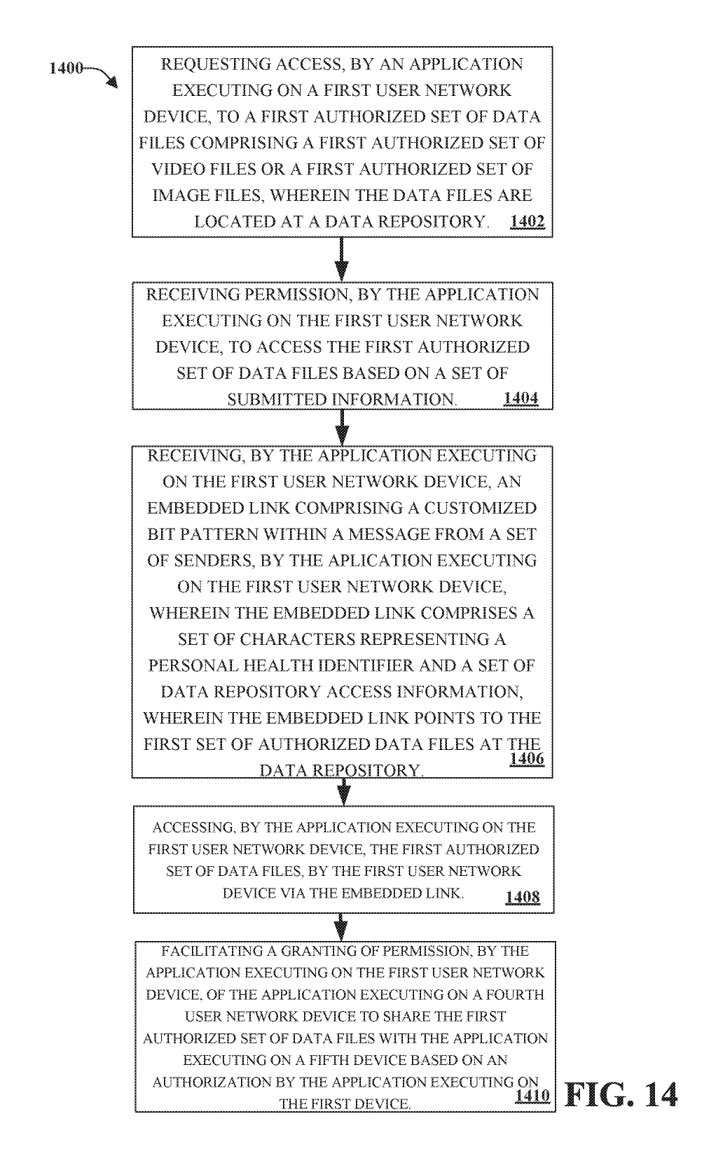

FIG. 14 illustrates a flow chart of an example method 1400 for accessing medical records using an application executing on a network device. At 1402, an application execution on a first user network device, requests (e.g., using request component 210) access to a first authorized set of data files comprising a first authorized set of video files or a first authorized set of image files, wherein the data files are located at a data repository 126. At 1404, the application executing on the first user network device receives permission receives permission (e.g., using permission component 220) to access the first authorized set of data files based on a set of submitted information.

At 1406, the application executing on the first user network device receives an embedded link comprising a customized bit pattern within a claim message from a set of senders, wherein the embedded link comprises a set of characters representing a personal health identifier and a set of data repository access information, wherein the embedded link points to the first set of authorized data files at the data repository. At 1408, the application executing on the first user network device accesses the first authorized set of data files using the embedded link. At 1410, the application executing on the first user network device facilitates a granting of permission (e.g., using authorization component 910) of the application executing on a fourth user network device to share the first authorized set of data files with the application executing on a fifth user network device.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

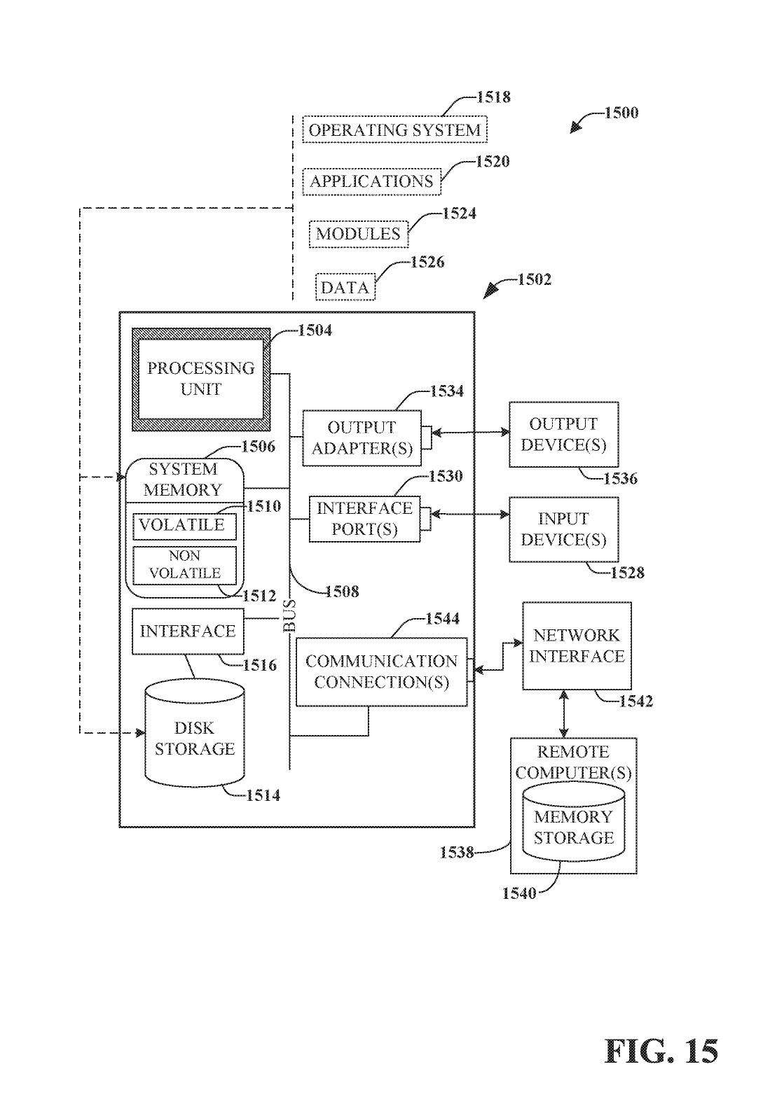

With reference to FIG. 15, a suitable environment 1500 for implementing various aspects of the claimed subject matter includes a computer 1502. The computer 1502 includes a processing unit 1504, a system memory 1506, a codec 1505, and a system bus 1508. The system bus 1508 couples system components including, but not limited to, the system memory 1506 to the processing unit 1504. The processing unit 1504 can be any of various available suitable processors. Dual microprocessors and other multiprocessor architectures also can be employed as the processing unit 1504.

The system bus 1508 can be any of several types of suitable bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Fire wire (IEEE 10104), and Small Computer Systems Interface (SCSI).

The system memory 1506 includes volatile memory 1510 and non-volatile memory 1512. The basic input/output system (BIOS), containing the basic routines to transfer information between elements within the computer 1502, such as during start-up, is stored in non-volatile memory 1512. In addition, according to present innovations, codec 1505 may include at least one of an encoder or decoder, wherein the at least one of an encoder or decoder may consist of hardware, a combination of hardware and software, or software. Although, codec 1505 is depicted as a separate component, codec 1505 may be contained within non-volatile memory 1512. By way of illustration, and not limitation, non-volatile memory 1512 can include read only memory (ROM), programmable ROM (PROM), electrically programmable ROM (EPROM), electrically erasable programmable ROM (EEPROM), or flash memory. Volatile memory 1510 includes random access memory (RAM), which acts as external cache memory. According to present aspects, the volatile memory may store the write operation retry logic (not shown in FIG. 15) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1502 may also include removable/non-removable, volatile/non-volatile computer storage medium. FIG. 15 illustrates, for example, disk storage 1514. Disk storage 1514 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1514 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1514 to the system bus 1508, a removable or non-removable interface is typically used, such as interface 1516.

It is to be appreciated that FIG. 15 describes software that acts as an intermediary between users and the basic computer resources described in the suitable operating environment 1500. Such software includes an operating system 1518. Operating system 1518, which can be stored on disk storage 1514, acts to control and allocate resources of the computer system 1502. Applications 1520 take advantage of the management of resources by operating system 1518 through program modules 1524, and program data 1526, such as the boot/shutdown transaction table and the like, stored either in system memory 1506 or on disk storage 1514. It is to be appreciated that the claimed subject matter can be implemented with various operating systems or combinations of operating systems.

A user enters commands or information into the computer 1502 through input device(s) 1528. Input devices 1528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1504 through the system bus 1508 via interface port(s) 1530. Interface port(s) 1530 include, for example, a serial port, a parallel port, a game port, and a universal serial bus (USB). Output device(s) 1536 use some of the same type of ports as input device(s). Thus, for example, a USB port may be used to provide input to computer 1502, and to output information from computer 1502 to an output device 1536. Output adapter 1534 is provided to illustrate that there are some output devices 1536 like monitors, speakers, and printers, among other output devices 1536, which require special adapters. The output adapters 1534 include, by way of illustration and not limitation, video and sound cards that provide a means of connection between the output device 1536 and the system bus 1508. It should be noted that other devices and/or systems of devices provide both input and output capabilities such as remote computer(s) 1538.

Computer 1502 can operate in a networked environment using logical connections to one or more remote computers, such as remote computer(s) 1538. The remote computer(s) 1538 can be a personal computer, a server, a router, a network PC, a workstation, a microprocessor based appliance, a peer device, a smart phone, a tablet, or other network node, and typically includes many of the elements described relative to computer 1502. For purposes of brevity, only a memory storage device 1540 is illustrated with remote computer(s) 1538. Remote computer(s) 1538 is logically connected to computer 1502 through a network interface 1542 and then connected via communication connection(s) 1544. Network interface 1542 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1544 refers to the hardware/software employed to connect the network interface 1542 to the bus 1508. While communication connection 1544 is shown for illustrative clarity inside computer 1502, it can also be external to computer 1502. The hardware/software necessary for connection to the network interface 1542 includes, for exemplary purposes only, internal and external technologies such as, modems including regular telephone grade modems, cable modems and DSL modems, ISDN adapters, and wired and wireless Ethernet cards, hubs, and routers.

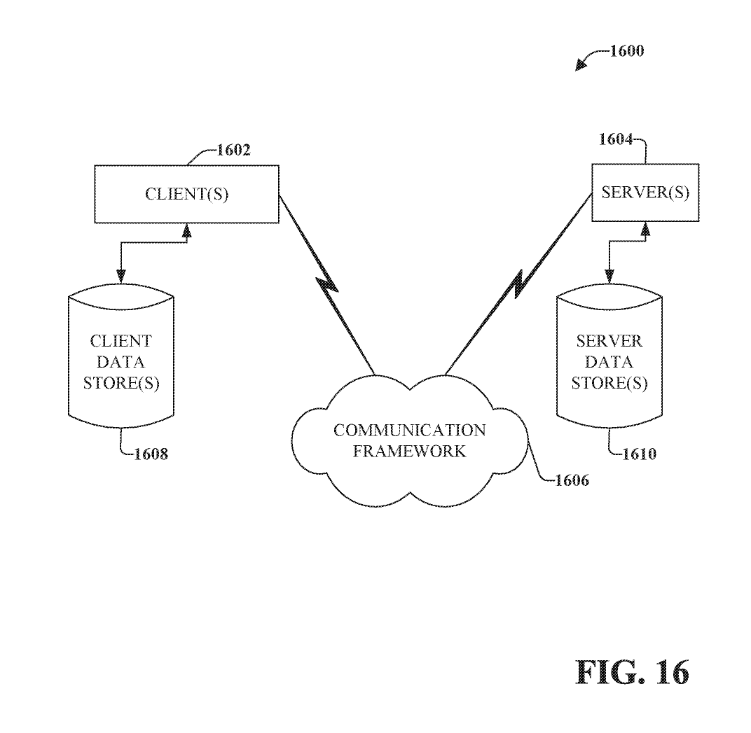

Referring now to FIG. 16, there is illustrated a schematic block diagram of a computing environment 1600 in accordance with this disclosure. The system 1600 includes one or more client(s) 1602 (e.g., laptops, smart phones, PDAs, media players, computers, portable electronic devices, tablets, and the like). The client(s) 1602 can be hardware and/or software (e.g., threads, processes, computing devices). The system 1600 also includes one or more server(s) 1604. The server(s) 1604 can also be hardware or hardware in combination with software (e.g., threads, processes, computing devices). The servers 1604 can house threads to perform transformations by employing aspects of this disclosure, for example. One possible communication between a client 1602 and a server 1604 can be in the form of a data packet transmitted between two or more computer processes wherein the data packet may include video data. The data packet can include a metadata, e.g., associated contextual information, for example. The system 1600 includes a communication framework 1606 (e.g., a global communication network such as the Internet, or mobile network(s)) that can be employed to facilitate communications between the client(s) 1602 and the server(s) 1604.

Communications can be facilitated via a wired (including optical fiber) and/or wireless technology. The client(s) 1602 include or are operatively connected to one or more client data store(s) 1608 that can be employed to store information local to the client(s) 1602 (e.g., associated contextual information). Similarly, the server(s) 1604 are operatively include or are operatively connected to one or more server data store(s) 1610 that can be employed to store information local to the servers 1604.

In one embodiment, a client 1602 can transfer an encoded file, in accordance with the disclosed subject matter, to server 1604. Server 1604 can store the file, decode the file, or transmit the file to another client 1602. It is to be appreciated, that a client 1602 can also transfer uncompressed file to a server 1604 and server 1604 can compress the file in accordance with the disclosed subject matter. Likewise, server 1604 can encode video information and transmit the information via communication framework 1606 to one or more clients 1602.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from a computer-readable device or storage media.

1. A system comprising:
a memory that stores computer executable components;
a processor that executes at least the following computer executable components stored in the memory:
a request component that requests access, by an application executing on a first device, to a first authorized set of data files comprising a first authorized set of video files or a first authorized set of image files, wherein the data files are located at a data repository;
a permission component that receives permission, by the application executing on the first device, to access the first authorized set of data files based on a set of submitted information;
a messaging component that receives, by the application executing on the first device, an embedded link within a message from a set of senders, wherein the embedded link comprises a customized bit pattern, a set of characters representing a personal health identifier and a set of data repository access information, and wherein the embedded link points to the first set of authorized data files at the data repository; and
an access component that accesses, by the application executing on the first device, the first authorized set of data files via the embedded link.

2. The system of claim 1, wherein the permission component employs a verification component that verifies that the application executing on the first device is authorized to access the first authorized set of data files based on a first identifier associated with the first device.

3. The system of claim 1, wherein the submitted information is an activation code.

4. The system of claim 1, further comprising a notification component that provides a notification that a message or a data file of the first authorized set of data files is received or sent.

5. The system of claim 1, wherein the first authorized set of image files are a set of medical images and the first authorized set of video files are a set of medical videos, wherein the set of medical images and the set of medical videos are derived from medical record data files associated with the first device.

6. The system of claim 1, wherein the set of senders comprises an origin sender using a first messaging system and a subset of subsequent senders of the set of senders, wherein the subset of subsequent senders use at least one corresponding subsequent messaging system, and wherein the at least one corresponding subsequent messaging system is different from the first messaging system.

7. The system of claim 6, wherein the customized bit pattern is compatible with the first messaging system and the at least one corresponding subsequent messaging system.

8. The system of claim 1, further comprising a selection component that selects the first authorized set of data files, via the application executing on a third device, from a set of data files comprising the first authorized set of data files and a set of unauthorized data files.

9. The system of claim 1, further comprising a sharing component that shares a subset of authorized data files of the first authorized set of data files with the application executing on a second device based on a second identifier associated with the second device.

10. The system of claim 1, further comprising incorporation component that facilitates the incorporation, by the application executing on the first device, of a second authorized set of data files to the first authorized set of data files.

11. The system of claim 2, further comprising restriction component that restricts the application executed on a second device from sharing the first authorized set of data files.

12. The system of claim 1, further comprising authorization component that facilities a granting of permission, by the first device, to a fourth device to share the first authorized set of data files with a fifth device.

13. A method, comprising:
requesting access, by an application executing on a first user network device, to a first authorized set of data files comprising a first authorized set of video files or a first authorized set of image files, wherein the data files are located at a data repository;
receiving permission, by the application executing on the first user network device, to access the first authorized set of data files based on a set of submitted information;
receiving, by the application executing on the first user network device, an embedded link comprising a customized bit pattern within a message from a set of senders, by the first device, wherein the embedded link comprises a set of characters representing a personal health identifier and a set of data repository access information, wherein the embedded link points to the first set of authorized data files at the data repository; and
accessing, by the application executing on the first user network device, the first authorized set of data files, by the first user network device, via the embedded link.

14. The method of claim 13, further comprising providing, by the application executing on the user device, a notification that a message or a data file of the first authorized set of data files is received or sent.

15. The method of claim 13, further comprising selecting, by the application executing on the first user network device, the first authorized set of data files, via the application executing on a third user network device, from a set of data files comprising the first authorized set of data files and a set of unauthorized data files.

16. The method of claim 13, further comprising sharing, by the application executing on the first user network device, a subset of authorized data files of the first authorized set of data files with the application executing on a second user network device based on a second identifier associated with the second user network device.

17. The method of claim 13, further comprising facilitating a granting of permission, by the application executing on the first user network device, of the application executing on a fourth user network device to share the first authorized set of data files with the application executing on a fifth user network device based on an authorization by the application executing on the first device.

18. A system comprising:
a memory that stores computer executable components;
a processor that executes at least the following computer executable components stored in the memory:
a request component that sends a request to access, by a first device comprising a first system, a first set of data files comprising a first set of medical video files or a first set of medical image files, wherein the data files are located at data repository comprising a second system;
a permission component that grants permission to the first device to access the first authorized set of data files based on a set of submitted information;
a messaging component that receives an embedded link within a message, wherein the embedded link comprises a customized bit pattern, a set of characters representing a personal health identifier, and a set of data repository access information, wherein the embedded link points to the first set of authorized data files at the data repository, and wherein the customized bit pattern is compatible with the first system and the second system; and
an access component that accesses the authorized set of first data files, by the first device, using the embedded link.

19. The system of claim 18, further comprising information component that incorporates a set of health data into the first set of authorized data.

20. The system of claim 18, further comprising management component that facilitates management of the first set of authorized data based on a set of classifiers and a set of organizational frameworks.
